(19) United States
(12) Patent Application Publication
(10) Pub. No.: US 2023/0150459 A1
(43) Pub. Date: May 18, 2023

(54) METHOD FOR OPERATING A BRAKE SYSTEM OF A MOTOR VEHICLE, COMPUTER PROGRAM PRODUCT, CONTROL UNIT AND BRAKE SYSTEM

(71) Applicant: ZF Active Safety GmbH, Koblenz (DE)

(72) Inventor: Boris Koeth, Weitersburg (DE)

(21) Appl. No.: 17/989,235

(22) Filed: Nov. 17, 2022

(30) Foreign Application Priority Data
Nov. 18, 2021 (DE) 10202113083.1

(51) Int. Cl. B60T 7/04; B60T 13/68; B60T 8/40

(52) U.S. Cl. CPC B60T 7/042; B60T 13/686; B60T 8/4077

(57) ABSTRACT

A method for operating a brake system of a motor vehicle, wherein the brake system has a brake pedal, which can be actuated by a driver of the motor vehicle, a brake booster, which can be coupled or is coupled to the brake pedal, a brake cylinder, such as a brake master cylinder, which can be coupled or is coupled to the brake booster and can be supplied with hydraulic fluid, and a hydraulic arrangement, which acts between the brake cylinder and at least one wheel brake, wherein the method comprises at least the step of: decoupling the brake pedal from the at least one wheel brake by the hydraulic arrangement, and a computer program, control unit or system having a plurality of control units and brake system.

### CROSS-REFERENCE TO RELATED APPLICATION

This application claims priority to German Priority Application No. 102021130183.1, filed Nov. 18, 2021, the disclosure of which is incorporated herein by reference in its entirety.

### TECHNICAL FIELD

The disclosure relates to a method for operating a brake system, a computer program and a control unit, and a system comprising a plurality of control units for a motor vehicle. The disclosure also relates to a brake system.

### BACKGROUND

Motor vehicles usually have hydraulic brake systems with electromechanical brake boosters (electronic brake boosters, EBB actuators) coupled to the brake pedal, by which the vehicle can be slowed down and stopped. In the case of an autonomous or partially autonomous driving mode, unwanted braking by the driver can occur if the latter unintentionally actuates the brake pedal. During longer autonomous journeys, it may also happen that the driver falls asleep and accidentally actuates the brake pedal with his foot. As a result, driving safety is impaired.

### SUMMARY

What is needed is to functionally improve a method mentioned at the outset. In addition, what is needed is that of structurally and/or functionally improving a computer program mentioned at the outset and a control unit or control system mentioned at the outset. Furthermore, what is also needed is that of structurally and/or functionally improving a brake system mentioned at the outset.

A method can be and/or serve for operating a brake system of a motor vehicle. The motor vehicle can be a passenger car or a truck. The brake system can be a vehicle brake system and/or a motor vehicle brake system.

The brake system can be designed to be actuated by a driver of the motor vehicle and/or independently of the driver. A braking operation initiated by a driver by the brake pedal may be referred to as service braking. In the case of service braking, the hydraulic pressure in the brake circuits is generated by the driver himself, for example directly or indirectly by activation of a pump, such as a hydraulic pump. In the context of service braking initiated by the driver, or independently thereof, a driving safety system and/or driving dynamics control system can bring about a braking operation, referred to as system braking, independently of the driver, for example by a brake booster. The timing of the system braking can overlap with that of service braking or can take place at a separate time from service braking. The brake system can be designed to be controlled autonomously or partially autonomously, for example by a control unit or a system comprising a plurality of control units. The brake system can have what is referred to as 2-box architecture.

The brake system can have a brake pedal. The brake pedal can be actuable or actuated by a driver of the motor vehicle. The brake system can have a brake booster. The brake booster can be couplable or coupled to the brake pedal. The brake booster can be an electromechanical brake booster (electronic brake booster, EBB actuators). The brake system has a brake cylinder, such as a brake master cylinder. The brake cylinder can be couplable or coupled to the brake booster. The brake cylinder can be suppliable or supplied with hydraulic fluid. The brake system can comprise at least one wheel brake. Instead of the designation “wheel”, the designation “tyre” can be chosen above and/or below. The brake system can comprise, for example, two, three or four wheel brakes. The brake system can have a hydraulic arrangement. The hydraulic arrangement can be or become effective between the brake cylinder and the at least one wheel brake. The brake cylinder can be designed to build up a hydraulic pressure at the at least one wheel brake, for example via the hydraulic arrangement. The at least one wheel brake can be hydraulically actuable. The brake cylinder can be designed to build up a hydraulic pressure at a plurality of, for example two, three or four, wheel brakes. The hydraulic pressure can be a hydraulic fluid pressure and/or brake pressure. The brake cylinder can have a piston, such as an input piston, a master cylinder piston or a brake master cylinder piston. The brake pedal can be designed to actuate the brake cylinder and/or piston mechanically. The piston can be operatively coupled, for example mechanically and/or electrically, to the brake pedal. The piston can be operatively coupled, for example mechanically, to the brake booster.

The brake system can have a wheel brake pressure control device. The wheel brake pressure control device can be designed to perform control interventions at the at least one wheel brake of the motor vehicle. The wheel brake pressure control device can be set up to control the hydraulic pressure or brake pressure at one or more wheel brakes by a rapid succession of pressure-holding, pressure build-up and/or pressure-reducing phases, for example in order to avoid locking up or spinning of one or more wheels of the vehicle. The wheel brake pressure control device can include the hydraulic arrangement. The wheel brake pressure control device can be designed to be controlled autonomously or partially autonomously, for example by a control unit or a system comprising a plurality of control units.

The brake system can comprise a driving dynamics control system, for example an anti-lock braking system (ABS) and/or an electronic stability control (ESP or ESC). The driving dynamics control system can comprise one or more functions, such as an anti-slip control system (ASR), an anti-lock braking system (ABS) and/or an electronic braking force distribution system (EBV). The brake system can include a traction control system (TC). The brake system can be designed as a brake-by-wire system (BBW system). The brake system can be equipped with an electric brake boost system (EBB system) and/or can be designed in such a way. The brake booster and/or the brake cylinder can be part of the electric brake boost system. In the EBB system, the force applied by the driver to the brake pedal can be intensified by the brake booster. The wheel brake pressure control device can be and/or include a driving safety system and/or driving dynamics control system, for example an ABS and/or TC and/or ESC control device.

The method can comprise the step of: decoupling, for example hydraulic decoupling, of the brake pedal from the at least one wheel brake by the hydraulic arrangement.

Decoupling can take place at least temporarily. Decoupling can take place during an autonomous or partially autonomous driving mode. The hydraulic arrangement can be activated in such a way that the brake pedal is decoupled from the at least one wheel brake at least temporarily and/or during an autonomous or partially autonomous driving mode.

The hydraulic arrangement can have a valve arrangement. The valve arrangement can be activated in order to decouple the brake pedal from the at least one wheel brake. The valve arrangement can have one or more valves and/or pump devices/pumps, which can be activated accordingly.

The brake system and/or the hydraulic arrangement can have at least one brake circuit. At least one wheel brake can be assigned to the at least one brake circuit and/or can be actuable or actuated via the latter. For example, the brake system and/or the hydraulic arrangement can have two brake circuits. Two wheel brakes can be assigned to each brake circuit and/or can be actuable or actuated via the latter.

The at least one brake circuit can have at least one first shut-off valve (TC_ISO). The first shut-off valve can be designed for hydraulically separating the at least one wheel brake and/or the at least one brake circuit from the brake cylinder and/or can be activated in this way.

The at least one brake circuit can have at least one second shut-off valve (ABS_NO, ABS_ISO). The at least one second shut-off valve can be assigned to the at least one wheel brake. A second shut-off valve can be assigned to each wheel brake. The at least one second shut-off valve can be designed for hydraulically separating the at least one wheel brake from the brake cylinder and/or can be activated in this way. The at least one second shut-off valve can be designed for hydraulically separating the at least one wheel brake from an outlet side of a pump, such as a hydraulic pump, and/or can be activated in this way. The at least one brake circuit can have the pump, such as a hydraulic pump.

The at least one brake circuit can have a third shut-off valve (ABS_NC, Dump). The third shut-off valve can be arranged at least in the return line of the at least one wheel brake. The at least one third shut-off valve can be assigned to the at least one wheel brake. A third shut-off valve can be assigned to each wheel brake.

The at least one first shut-off valve and/or the at least one second shut-off valve and/or the at least one third shut-off valve can be activated in such a way as to open this/these or to allow hydraulic fluid to pass through. It is thereby possible to effect decoupling, for example hydraulic decoupling, of the brake pedal from the at least one wheel brake.

The at least one first shut-off valve and/or the at least one second shut-off valve and/or the at least one third shut-off valve can be designed as N.C. (normally closed) valves. The at least one first shut-off valve and/or the at least one second shut-off valve and/or the at least one third shut-off valve can be designed as N.O. (normally open) valves. In the case of an exemplary arrangement as N.C. (normally closed), the valve is closed in the idle position, for example by spring force, and, in the case of an exemplary arrangement as N.O. (normally open), is open.

The at least one brake circuit can comprise an accumulator, for example a fluid accumulator, and the fluid accumulator can be a volume accumulator and/or pressure accumulator and/or hydraulic accumulator and/or low-pressure accumulator (LPA). The accumulator can be assigned to at least one wheel brake, for example two wheel brakes. The accumulator, such as a fluid accumulator, can be connected to the pump, such as a hydraulic pump, on the inlet side. The accumulator, such as a fluid accumulator, can be connected to and/or brought into connection with the return line of the at least one wheel brake, to/with the outlet side of the at least one third shut-off valve. For example, the accumulator, such as a fluid accumulator, can be connected to and/or brought into connection with the return lines of two wheel brakes, to/with the outlet sides of the two third shut-off valves. In the accumulator, such as a fluid accumulator, hydraulic fluid can be stored, for example temporarily stored, or put into storage. When the at least one first shut-off valve and/or the at least one second shut-off valve and/or the at least one third shut-off valve are/is open, hydraulic fluid can be stored, for example temporarily stored, or put into storage in the accumulator, such as a fluid accumulator.

The accumulator, such as a fluid accumulator, can be in a state of activation or can be activated. The accumulator, such as a fluid accumulator, can be open or opened. The accumulator, such as a fluid accumulator, can be actuated, for example, by a piston movement, of a piston of the accumulator or its piston/spring arrangement, for example in such a way that hydraulic fluid is returned to the brake circuit from the accumulator. The accumulator, such as a fluid accumulator, can be controlled in such a way that hydraulic fluid is returned to the brake circuit from the accumulator. When the at least one first shut-off valve and/or the at least one second shut-off valve and/or the at least one third shut-off valve are/is open, the accumulator, such as a fluid accumulator, can be controlled in such a way that hydraulic fluid is returned to the brake circuit from the accumulator. Hydraulic fluid from the accumulator, such as a fluid accumulator, can be fed back in such a way that the brake pedal is moved and/or pushed back, being moved and/or pushed back by a pedal travel which is opposite to the actuating travel of the brake pedal, for example. The actuating travel of the brake pedal can be the actuating travel over which the brake pedal is displaced or moved during actuation by the driver. In addition or as an alternative, the pump, such as a hydraulic pump, can be activated, with the result that the brake pedal is moved and/or pushed back, by the hydraulic fluid fed back by the pump, by a pedal travel which is opposite to the actuating travel of the brake pedal. The movement and/or pushing back of the brake pedal can be accomplished by the brake cylinder, which is acted upon by the hydraulic fluid, for example the hydraulic fluid fed back. The pedal travel can be between about 20 mm and about 120 mm. The pedal travel can be about 40 mm or about 80 mm, for example. The pedal travel can be over 80 mm. The force, such as pedal force, can be between 20 and 100 N. The force, such as pedal force, can be about 60 N or 80 N, for example. The force, such as pedal force, can be less than 60 N or less than 80 N, for example. The share and/or hydraulic fluid taken up by the accumulator can be, for example, up to 2 cc or up to 5 cc. In the case of a share of the accumulator of up to 2 cc (circuit), for example, a pedal travel of 40 mm and/or a force of less than 60 N can be achieved. In the case of a share of the accumulator of up to 5 cc (circuit), a pedal travel of, for example, 80 mm and/or a force of less than 80 N can be achieved. In the case of isolation of the at least one second shut-off valve, a pedal travel of >80 mm can be achieved, for example.

The at least one second shut-off valve can be activated in such a way as to close it. The at least one second shut-off valve can be activated, with the result that the at least one wheel brake is separated from the brake cylinder and/or from the outlet side of the pump, such as a hydraulic pump. The at least one third shut-off valve can be activated in such a way as to close it. The at least one third shut-off valve can be activated, with the result that the at least one second shut-off valve is isolated.

The hydraulic arrangement can have a reservoir, such as a fluid reservoir. The reservoir can be used and/or designed to hold and/or store and/or contain a pressure medium, such as hydraulic fluid and/or brake fluid. The pressure medium can be for the brake system and/or the brake circuit or braking circuit. The pressure medium can be held and/or stored in the reservoir at atmospheric pressure or at other pressures.

The reservoir can be connected to the at least one brake circuit, for example by activating at least one valve and/or a valve arrangement. The reservoir can be connected to the at least one brake circuit in such a way that the brake pedal is decoupled, for example hydraulically, from the at least one wheel brake. The reservoir can receive and/or store hydraulic fluid. The at least one valve and/or a valve arrangement can be controlled in such a way that hydraulic fluid can be received and/or stored in the reservoir. The at least one valve and/or a valve arrangement can be controlled in such a way that the hydraulic fluid received and/or stored in the reservoir can be fed back to the brake circuit or braking circuit. The at least one valve and/or a valve arrangement can be controlled in such a way that the hydraulic fluid received and/or stored in the reservoir causes the brake pedal to be moved and/or pushed back, for example in the direction of the pedal travel which is opposite to the actuating travel of the brake pedal. In particular, the brake pedal can be moved away from the driver out of an initial position by displacing hydraulic fluid into the reservoir. The displacement of hydraulic fluid can take place when predetermined situation features for a vehicle crash and/or an automatic driving situation are detected. A vehicle crash is detected by a sensor device by information provided by the sensor device. An automatic driving situation is detected by an interior sensor device and/or on the basis of a driver command for activating an automated driving mode. In the automatic driving situation and/or a vehicle crash, the brake pedal is automatically moved away from the driver based on the detection of situation features. For this purpose, the brake booster and control valves of the brake system are appropriately activated, ensuring that a movement of the brake pedal has no influence on an automated braking function carried out in an appropriate manner depending on the situation.

By operation of the brake pedal, for example by the movement and/or pushing back of the brake pedal by the pedal travel, a haptic feedback message for the driver can be generated. It is thereby possible, for example, to wake up a driver who is asleep.

The brake booster can have a motor, such as a servo motor and/or electric motor. The brake booster and/or the motor of the brake booster can be activated in such a way that the brake booster does not exert or cannot exert any force, such as servo force, on the brake cylinder. The force, such as servo force, can have the value zero.

The brake system can be coupled and/or connected to a generator device. The brake system can have the brake generator device. The generator device can be used or designed for regenerative braking. The generator device can be activated in such a way that no generator torque is generated or can be generated. The brake system and/or the generator device can be activated in such a way that no generator torque is demanded or can be demanded. The generator torque can have the value zero. The demand for the generator torque can have the value zero.

The method described above and/or below can be carried out in an autonomous or partially autonomous driving mode of the motor vehicle.

The brake system can be designed and/or configured to carry out the method described above and/or below.

A computer program can comprise a program code for carrying out the method described above and/or below, for operating a brake system, when the computer program is executed on a processor. A computer program can cause a device such as a, for example electronic, controller and/or control and/or processing unit/device, a control system, a driver assistance system, a brake system, such as a vehicle brake installation/system, a processor or a computer, to carry out the method described above and/or below, for example for operating a brake system. For this purpose, the computer program can have corresponding data records and/or program code and/or the computer program and/or a storage medium for storing the data records or the program.

A control unit or a system comprising a plurality of control units can be used in a motor vehicle. The brake system can comprise the control unit or the system comprising a plurality of control units.

The control unit or the system can be configured and intended for use in a motor vehicle. The control unit or the system can have an electronic controller. The control unit or the system can be or have an electronic control unit (ECU). It is possible to provide a plurality of control units. The plurality of control units can be connected via a bus system, for example a “controller area network” (CAN), and/or can exchange data with one another. The electronic controller and/or the control unit or system can have a microcomputer and/or processor. The control unit or system can comprise one or more sensors. The control unit or system can comprise the computer program described above and/or below. The control unit or the system can have a memory. The computer program can be stored in the memory. The control unit or system can be designed to carry out the method described above and/or below.

In other words, a pedal, such as a brake pedal, of a brake system can be in a decoupled state or can be decoupled, for example for autonomous driving. The brake system can have a 2-box architecture. The brake actuation, by the pedal, can be in a decoupled state or can be decoupled. A chauffeur service can be provided. Even in a fall-back level, there can also be a decoupled pedal, or the pedal can be in a decoupled state or can be decoupled. A haptic feedback, such as force feedback, for example “waking up” a sleeping driver, for example when using the pedal in autonomous driving, can be provided or carried out. A low-pressure accumulator (LPA) may be provided. The low-pressure accumulator can be in an activated state or can be activated and/or can be open or opened. The low-pressure accumulator can be a volume accumulator. The low-pressure accumulator can accept and/or be subjected to 1.3 to 2 bar, for example. The pedal can be in a coupled state with respect to or can be coupled, such as interlinked, to a brake booster, for example an electromechanical brake booster (EEB). The force blends can be 0 to 100% servo power. The servo force can be zero or equal to zero. The driver can be in a decoupled state or can be decoupled from at least one wheel brake or from an activation possibility of at least one wheel brake. At least one wheel brake can be in a decoupled state or can be decoupled. The at least one wheel brake can be in a decoupled state or can be decoupled by a hydraulic arrangement, such as an ESC hybrid. What is referred to as “pedal force blending” can be carried out with the brake booster. What is referred to as “brake blending” can be carried out with the hydraulic arrangement, such as an ESC hybrid. The brake system can have a generator or can be coupled thereto. Energy recovery can be active up to 1 g. A share of a generator can be up to 0.3 g. A generator torque can be zero or equal to zero. The demand for a generator torque can be zero. A share of the low-pressure accumulator can be up to 2 cc (circuit). As a result, the pedal travel can be about 40 mm. In this case, the force, such as pedal force, can be less than 60 N for instance. A share of the low-pressure accumulator can be up to 5 cc (circuit). As a result, the pedal travel can be about 80 mm. In this case, the force, such as pedal force, can be less than 80 N for instance. The hydraulic arrangement, such as an ESC hybrid, can have at least one ABS_ISO valve. The at least one ABS_ISO valve can be in an isolated state or can be isolated. As a result, the pedal travel can be greater than 80 mm. The at least one ABS_ISO valve can be in a closed state or can be closed. It is thereby possible to provide a “hard” pedal. A reservoir and/or reservoir connection can be provided. An open system with a reservoir and/or reservoir connection can be provided. The reservoir and/or the reservoir connection can serve and/or be designed for decoupling the pedal and/or driver and/or the at least one wheel brake.

With the disclosure, safety during autonomous or partially autonomous driving can be increased. Accidental braking force generation, for example by a sleeping driver, can be avoided. A sleeping driver can be woken up, for example by haptic feedback, such as force feedback, of the brake pedal.

Exemplary arrangements of the disclosure are described in greater detail below with reference to figures, which are schematic and provided by way of example and of which:

### BRIEF DESCRIPTION OF DRAWINGS

FIG. 1 shows a brake system with a hydraulic arrangement in a first exemplary configuration; and

FIG. 2 shows the brake system according to FIG. 1 with the hydraulic arrangement in a second exemplary configuration.

### DETAILED DESCRIPTION

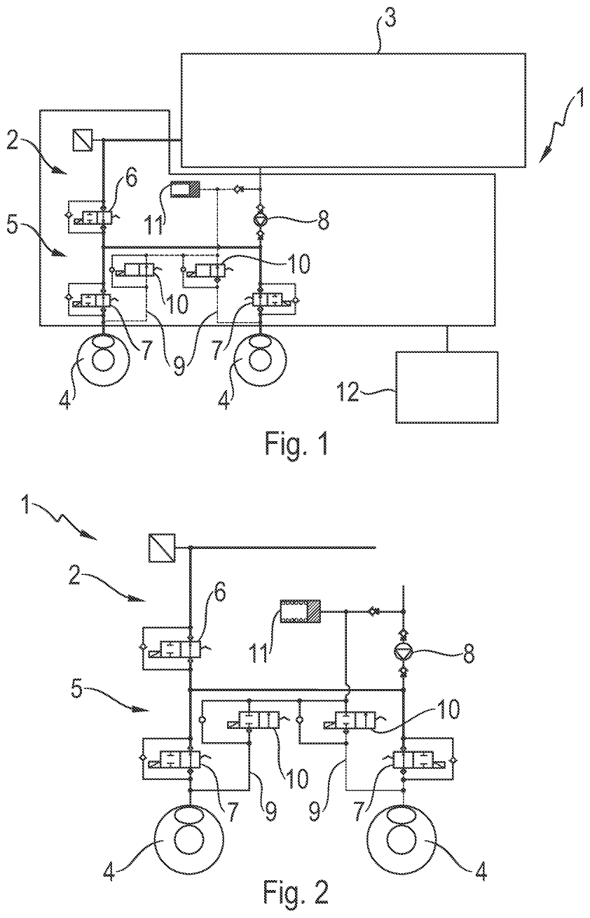

FIG. 1 shows schematically a brake system 1 with a hydraulic arrangement 2, such as an ESC hybrid, in a first configuration (state of valves).

The brake system 1 has a brake pedal, which can be actuated by a driver of the motor vehicle, a brake booster 3, which can be coupled or is coupled to the brake pedal, and a brake cylinder, such as a brake master cylinder, which can be coupled or is coupled to the brake booster 3 and can be supplied with hydraulic fluid. The hydraulic arrangement 2 acts between the brake cylinder and the at least one wheel brake 4. The hydraulic arrangement 2 is connected, on the one hand, to the brake cylinder, for example by fluid technology, such as a fluid line, and, on the other hand, to the at least one wheel brake 4, for example by a fluid line. The hydraulic arrangement 2 illustrated in FIG. 1 has a brake circuit, such as a braking circuit, which is connected to two wheel brakes 4 (VR, HL). The hydraulic arrangement 2 can also have a further, second brake circuit, which in turn is connected to two wheel brakes 4.

A method for operating the brake system, for example carried out by the brake system 1, comprises the step of decoupling, such as hydraulic decoupling, of the brake pedal from the at least one wheel brake 4 by the hydraulic arrangement 2. Decoupling can take place at least temporarily and/or during an autonomous or partially autonomous driving mode. The hydraulic arrangement 2 can be activated in such a way that the brake pedal is decoupled from the at least one wheel brake 4 at least temporarily and/or during the autonomous or partially autonomous driving mode.

The hydraulic valve arrangement 2 has a valve arrangement 5, which can be activated in order to decouple the brake pedal from the at least one wheel brake 4. The at least one brake circuit of the hydraulic arrangement 2 has at least one first shut-off valve 6 (TC_ISO) for hydraulically separating the at least one wheel brake 4 and/or the at least one brake circuit from the brake cylinder. Furthermore, the at least one brake circuit of the hydraulic arrangement 2 has at least one second shut-off valve 7 (ABS_NO, ABS_ISO), which is assigned to the at least one wheel brake 4, for hydraulically separating the at least one wheel brake 4 from the brake cylinder and/or from an outlet side of a pump 8, such as a hydraulic pump 8. Furthermore, the at least one brake circuit of the hydraulic arrangement 2 has at least one third shut-off valve 10 (ABS_NC, dump), which is arranged in the return line 9 of the at least one wheel brake 4.

The at least one first shut-off valve 2, the at least one second shut-off valve 7 and the at least one third shut-off valve 10 are activated in such a way as to open these.

The at least one brake circuit of the hydraulic arrangement 2 has a fluid accumulator 11, such as a volume accumulator and/or pressure accumulator and/or low-pressure accumulator, which is connected on the inlet side to the hydraulic pump 8 and is connected to the return line 9 of the at least one wheel brake 4, to the outlet side of the at least one third shut-off valve 10. When at least one first, second and third shut-off valve 6, 7, 10 is open, hydraulic fluid can flow into the fluid accumulator 11 and be stored, in one exemplary arrangement, temporarily stored, in the fluid accumulator 11.

When the fluid accumulator 11 is activated, e.g. opened, hydraulic fluid is fed back in such a way that the brake pedal is moved and pushed back by a pedal travel which is opposite to the actuating travel of the brake pedal. In addition, or as an alternative, the hydraulic pump 8 can be activated, with the result that the brake pedal is moved and pushed back by a pedal travel which is opposite to the actuating travel of the brake pedal. The at least one second shut-off valve 7 can additionally or alternatively be activated in such a way in order to close the latter that the at least one wheel brake 4 is separated from the brake cylinder and/or from the outlet side of the hydraulic pump 8. In addition, or as an alternative, the hydraulic arrangement 2 can have a reservoir, such as a fluid reservoir, which is connected to the at least one brake circuit of the hydraulic arrangement 2 in such a way that the brake pedal is decoupled, for example hydraulically, from the at least one wheel brake 4.

The brake system 1 is designed and/or configured to carry out the method described above and/or below.

By operation of the brake pedal, for example by the movement and/or pushing back of the brake pedal by a pedal travel, a haptic feedback message for the driver can be generated.

The brake booster 3 has a motor, such as a servo motor, wherein the brake booster 3 and/or the motor of the brake booster 3 are/is activated in such a way that the brake booster 3 does not exert or cannot exert any force, such as servo force, on the brake cylinder. The force, such as servo force, can have the value zero (F=0). The brake system 1 is furthermore coupled to a generator device 12, for regenerative braking, wherein the generator device 12 is activated in such a way that no generator torque (M=0) is generated or can be generated.

FIG. 2 shows the brake system 1 according to FIG. 1 with the hydraulic arrangement 2 in a second configuration (state of the valves).

In contrast to the configuration of the hydraulic arrangement 2 illustrated in FIG. 1, the at least one third shut-off valve 10 (ABS_NC, dump) in the configuration illustrated according to FIG. 2 is activated in such a way as to close it, with the result that the at least one second shut-off valve 7 (ABS_NO, ABS_ISO) is isolated. It is thereby possible to produce a greater pedal travel, for example greater than 80 mm.

In other respects, attention is additionally drawn, to FIG. 1 and the associated description.

In particular, “can” denotes optional features of the disclosure. Accordingly, there are also developments and/or exemplary arrangements of the disclosure which additionally or alternatively have the respective feature or features.

If necessary, it is also possible to select isolated features from the combinations of features disclosed here and, while breaking up a structural and/or functional relationship which may exist between the features, to use them in combination with other features to define the subject matter of a claim. The sequence and/or number of steps of the method can be varied.

1. A method for operating a brake system of a motor vehicle, wherein the brake system has a brake pedal, which can be actuated by a driver of the motor vehicle, a brake booster, which can be coupled or is coupled to the brake pedal, a brake cylinder, which can be coupled or is coupled to the brake booster and can be supplied with hydraulic fluid, and a hydraulic arrangement, which acts between the brake cylinder and at least one wheel brake, wherein the method comprises at least the step of:
decoupling of the brake pedal from the at least one wheel brake the hydraulic arrangement.

2. The method according to claim 1, wherein the decoupling is carried out at least temporarily and/or the decoupling is carried out during an autonomous or partially autonomous driving mode.

3. The method according to claim 1, wherein the hydraulic arrangement is activated in such a way that the brake pedal is decoupled from the at least one wheel brake at least temporarily and/or during an autonomous or partially autonomous driving mode.

4. The method according to claim 1, wherein the hydraulic arrangement has a valve arrangement which is activated in order to decouple the brake pedal from the at least one wheel brake.

5. The method according to claim 1, wherein the hydraulic arrangement has at least one brake circuit, wherein the at least one brake circuit comprises at least one first shut-off valve for hydraulically separating the at least one wheel brake and/or the at least one brake circuit from the brake cylinder, at least one second shut-off valve, which is assigned to the at least one wheel brake, for hydraulically separating the at least one wheel brake from the brake cylinder and/or from an outlet side of a pump, and at least one third shut-off valve, which is arranged in the return line of the at least one wheel brake, wherein the at least one first shut-off valve, the at least one second shut-off valve and the at least one third shut-off valve are activated in such a way as to open them.

6. The method according to claim 5, wherein the at least one brake circuit comprises a fluid accumulator, which is connected on the inlet side to the pump, such as a hydraulic pump, and/or is connected to the return line of the at least one wheel brake, to the outlet side of the at least one third shut-off valve, wherein hydraulic fluid is stored, in the fluid accumulator when the at least one first, second and third shut-off valve are open.

7. The method according to claim 6, wherein the fluid accumulator is activated, wherein hydraulic fluid is fed back in such a way that the brake pedal is moved and/or pushed back by a pedal travel which is opposite to the actuating travel of the brake pedal.

8. The method according to claim 5, wherein the pump is activated, with the result that the brake pedal is moved and/or pushed back by a pedal travel which is opposite to the actuating travel of the brake pedal.

9. The method according to claim 5, wherein the at least one second shut-off valve is activated in such a way as to close it, with the result that the at least one wheel brake is separated from the brake cylinder and/or from the outlet side of the pump.

10. The method according to claim 5, wherein at least one third shut-off valve is activated in such a way as to close it, with a result that the at least one second shut-off valve is isolated.

11. The method according to claim 1, wherein the hydraulic arrangement has a reservoir, which is connected to the at least one brake circuit in such a way that the brake pedal is decoupled, from the at least one wheel brake.

12. The method according to claim 1, wherein movement and/or pushing back of the brake pedal by a pedal travel, a haptic feedback message for the driver is generated.

13. The method according to claim 1, wherein the brake booster has a motor, wherein the brake booster and/or the motor of the brake booster are/is activated in such a way that the brake booster does not exert or cannot exert any force, such as servo force, on the brake cylinder.

14. The method according to claim 1, wherein the brake system has a generator device, and/or is coupled to the generator, wherein the generator device is activated in such a way that no generator torque is generated or can be generated.

15. A computer program comprising a program code for carrying out a method according to claim 1, when the computer program product is executed on a processor.

16. A control unit or system comprising a plurality of control units for a motor vehicle, comprising at least one processor and the computer program according to claim 15.

17. A brake system for a motor vehicle, wherein the brake system is designed and/or configured to carry out the method according to claim 1.

18. The method according to claim 6, wherein the pump is activated, with the result that the brake pedal is moved and/or pushed back by a pedal travel which is opposite to the actuating travel of the brake pedal.

19. The method according to claim 7, wherein the at least one second shut-off valve is activated in such a way as to close it, with the result that the at least one wheel brake is separated from the brake cylinder and/or from the outlet side of the pump.

20. The method according to claim 9, wherein at least one third shut-off valve is activated in such a way as to close it, with a result that the at least one second shut-off valve is isolated.
